(19) United States
(12) Patent Application Publication
(10) Pub. No.: US 2010/0072044 A1
(43) Pub. Date: Mar. 25, 2010

(54) CIRCUIT BREAKER UNITARY CURRENT PATH

(75) Inventor: Wolfgang Meyer-Haack, Neumunster (DE)

Correspondence Address: CANTOR COLBURN, LLP, 20 Church Street, 22nd Floor, Hartford, CT, 06103, US

(73) Assignee: General Electric Company, Schenectady, NY (US)

(21) Appl. No.: 12/235,903

(22) Filed: Sep. 23, 2008

(51) Int. Cl. H01H 1/10; H01H 11/04

(52) U.S. Cl. 200/269; 29/622

(57) ABSTRACT

A unitary current path structure for a circuit breaker is provided. The unitary current path structure includes a terminal portion that is configured to couple with an electrical circuit. A flexible portion is coupled to the terminal portion. A movable portion is coupled to the flexible portion. The unitary current path structure is fabricated from a plurality of sheets stacked in a laminate arrangement. The terminal portion and movable portion are formed through a solidification process.

### BACKGROUND

The present invention relates to circuit breaker, and particularly relates to a circuit breaker having a unitary current path.

Circuit breakers are electrical devices that are installed in an electrical circuit to allow the connection and disconnection of the circuit from a power source. Circuit breakers have a subassembly commonly referred to as an interrupter. The interrupter is a switch that opens and closes to stop and start the flow of electrical current to the electric circuit. Circuit breaker interrupters are comprised of a number of components that are manually assembled using fasteners or through processes such as brazing. As a result, the complexity of interrupters tends to increase the cost of manufacturing circuit breakers. Further, since the interrupter is in the path of the electrical current, the mechanical joins formed by the assembly tend to increase the resistance of interrupter. This resistance leads to increased temperatures that can adversely impact performance ratings of the circuit breaker.

Accordingly, while present circuit breakers are suitable for their intended purposes, there is a need in the art for a current path arrangement that reduces the number of components required for assembly to reduce costs and increase reliability and performance.

### BRIEF DESCRIPTION OF THE INVENTION

A current path structure for a circuit breaker is provided. The current path structure includes a plurality of electrically conductive members arranged as a laminate. The plurality of electrically conductive members have a terminal portion, a movable portion, and a first flexible portion between the movable portion and the terminal portion, wherein material for each of the plurality electrically conductive members is contiguous between the terminal portion, the first flexible portion and the movable portion. Each of the terminal portions of the plurality of electrically conductive sheets are further electrically coupled to each other to form a unitary terminal. Each of the movable portions of the plurality of electrically conductive sheets are also electrically coupled to each other.

A circuit breaker is also provided having a housing. A first terminal is mounted within the housing. A unitary current path structure is provided comprised of a plurality of individual planar members, each of the plurality of individual planar members having a terminal portion, a movable portion and a flexible portion between the terminal portion and the movable portion. The terminal portions are electrically coupled to form a unitary second terminal, and the movable portions are electrically coupled to form a unitary contact arm. The unitary second terminal is also coupled to the housing and the unitary current path is arranged such that the unitary contact arm is movable between a first position in electrical contact with the first terminal and a second position that is separated from the first terminal.

A circuit breaker is also provided with a housing and a mechanism within the housing. A first terminal is positioned within the housing, and a current path structure coupled to the housing. The current path structure includes a plurality of electrically conductive members arranged as a laminate. The plurality of electrically conductive members have a terminal portion, a movable portion, and a first flexible portion between the movable portion and the terminal portion. The material for each of the plurality electrically conductive members is contiguous between the terminal portion, the first flexible portion and the movable portion. Wherein each of the terminal portions of the plurality of electrically conductive sheets are electrically coupled to each other to form a unitary second terminal. Additionally, each of the movable portions of the plurality of electrically conductive sheets are electrically coupled to each other to form at least one contact arm. The at least one contact arm is movable by the mechanism between a first position in electrical contact with the first terminal and a second position out of electrical contact with the first terminal.

A method of fabricating a unitary contact path for a circuit breaker is also provided. The method includes the step of forming a plurality of individual electrically conductive sheets, the sheets each having a terminal portion, a flexible portion and a movable portion. The plurality of individual electrically conductive sheets are stacked in a laminate arrangement, wherein the terminal portion, the flexible portion and the movable portion for each of the plurality of individual sheets are aligned. The terminal portion of the plurality of individual electrically conductive sheets are solidified to each other. The movable portion of the plurality of individual electrically conductive sheets are solidified to each other. Wherein the flexible portion is disposed between and contiguous with the terminal portion and the movable portion allowing the movable portion to move relative to the terminal portion.

### DRAWINGS

These and other features, aspects, and advantages of the present invention will become better understood when the following detailed description is read with reference to the accompanying drawings in which like characters represent like parts throughout the drawings, wherein:

FIG. 1 is schematic view of an electrical circuit with a circuit breaker in accordance with an exemplary embodiment;

FIG. 2 is a side plan view illustration of an embodiment of a circuit breaker having a unitary current path in the closed position accordance with an exemplary embodiment;

FIG. 3 is a side plan view illustration of the circuit breaker of FIG. 2 in the open position;

FIG. 4 is a plan view illustration of the unitary current path of FIG. 2;

FIG. 5 is another plan view illustration of the unitary current path of FIG. 2;

FIG. 6 is another plan view illustration of the unitary current path of FIG. 2;

FIG. 7 is a perspective view illustration of the unitary current path of FIG. 2;

FIG. 8 is a schematic illustration of a method for fabricating a unitary current path at a first intermediate process step;

FIG. 9 is a schematic illustration of the method for fabricating a unitary current path at a second intermediate process step;

FIG. 10 is a schematic illustration of the method for fabricating a unitary current path at a third intermediate process step; and

FIG. 11 is a flow chart illustration of a method for fabricating a unitary current path;

### DETAILED DESCRIPTION OF THE INVENTION

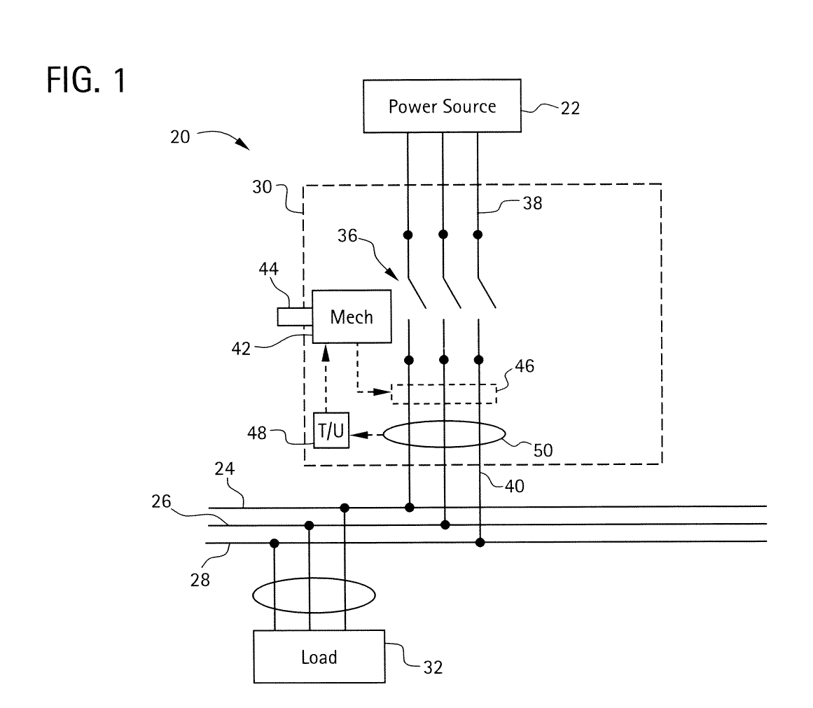

A variety of components are used in the delivery of electrical power to an end user. FIG. 1 shows an electrical circuit 20 with a power source 22, that provides 3-phase electrical power to three respective buses 24, 26, 28 protected by a signal controllable circuit breaker 30. Power is provided via the buses to one or more loads 32.

The circuit breaker 30 is generally arranged to open under abnormal operating conditions, such as a short circuit for example. The circuit breaker 30 further includes an interrupter portion 36 that is arranged to move between a closed state, where current flows from the power source 22 to the load 32, and an open state where the flow of electrical power ceases. The interrupter 36 is part of a current path through the circuit breaker 30 that provides an electrical connection between an inlet terminal 38 and an outlet terminal 40. As will be discussed in more detail below, the interrupter 36 also includes one or more contact arms that move to enable or disable the flow of electrical current. The interrupter 36 is coupled to a mechanism 42 that includes components such as springs and linkages, as is known in the art, to move the contact arms from a closed to an open position when activated by an operator through an opening switch or handle 44 for example. The mechanism may also use a trip bar assembly 46 that allows the interrupter 36 to open quickly in the event of an abnormal operating condition.

The mechanism 42 is also coupled to a trip unit 48. The trip unit 48 may be electronic, having a controller with a processor that executes computer instructions for controlling the operation of the circuit breaker 30. The trip unit 48 may also be a mechanical assembly incorporating components such as magnets or thermally responsive devices that activate the trip bar assembly 46 in the event of an abnormal operating condition. Where the trip unit 48 is an electronic unit, a set of current transformers 50 provide a signal indicative of the current level flowing through the circuit breaker 30 into the busses 24, 26, 28.

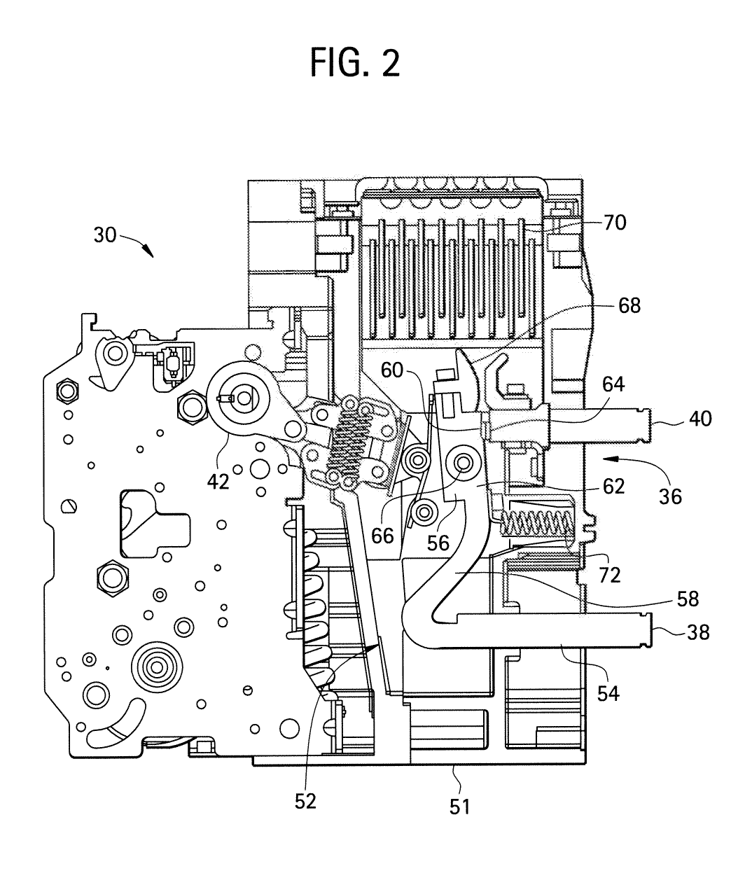

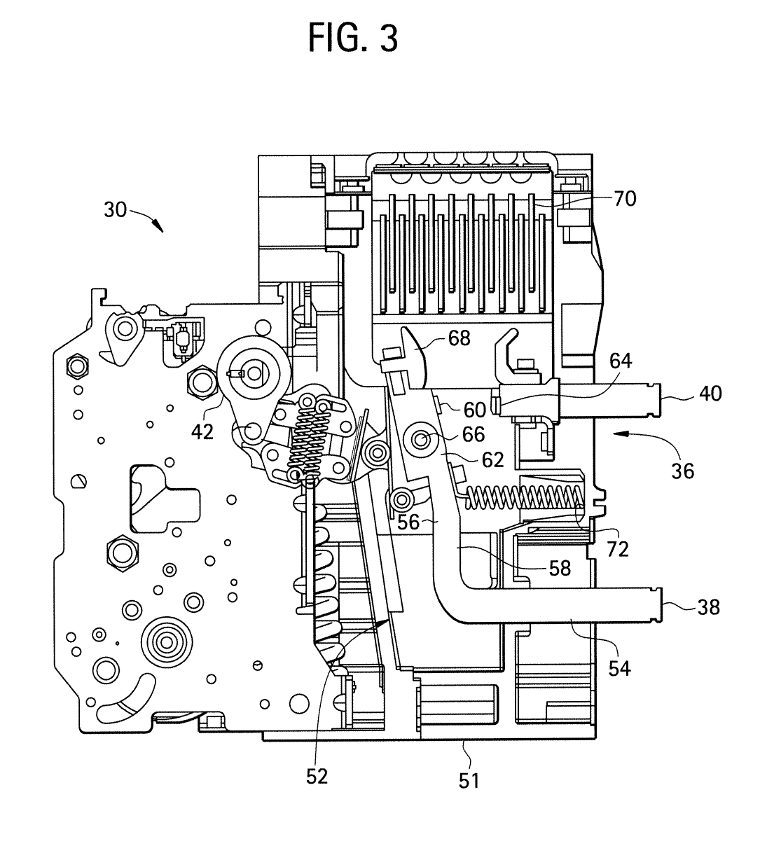

Referring now to FIGS. 2-3, the operation of the circuit breaker 30 will be described. The circuit breaker 30 is coupled to the electrical circuit 20 at the inlet terminal 38 and the outlet terminal 40 that are enclosed within a housing 51. As will be discussed in more detail below, the inlet terminal 38 is part of a unitary current path structure 52. The unitary current path structure 52 includes a terminal portion 54 and a movable portion 56. A flexible portion 58 connects the terminal portion 54 to the movable portion 56. The movable portion 56 includes a contact tip 60 that together form a contact arm assembly 62 that is in electrical contact with a stationary contact 64 when the circuit breaker 30 is in the closed position (FIG. 2). The contact arm assembly 62 is coupled to the mechanism 42 via a pin 66. In some embodiments, there may be multiple movable portions 56 extending from the terminal portion 54. In these embodiments, the pin 66 further couples the multiple movable portions 56 together. The contact arm assembly 62 may include further components such as arc runner 68 that facilitates the movement of a plasma arc formed during the separation of the electrical contacts into an arc chute 70.

During operation, the circuit breaker 30 moves between a closed position (FIG. 2) where electrical current flows through the circuit breaker 30 to the electrical circuit 20 and an open position (FIG. 3) where the flow of electrical current is halted. To stop the flow of electrical current, the mechanism 42 is unlocked, and a spring 72 applies a force biasing the movable contact 60 away from the stationary contact 64. Under the force of spring 72, the flexible portion 58 bends, allowing the contact arm assembly 62 to pivot away from the stationary contact 64. The separation of the movable contact 60 from the stationary contact 64 creates a momentary plasma arc that travels along the arc runner 68 and into the arc chute 70 where the energy is dissipated and the arc extinguished.

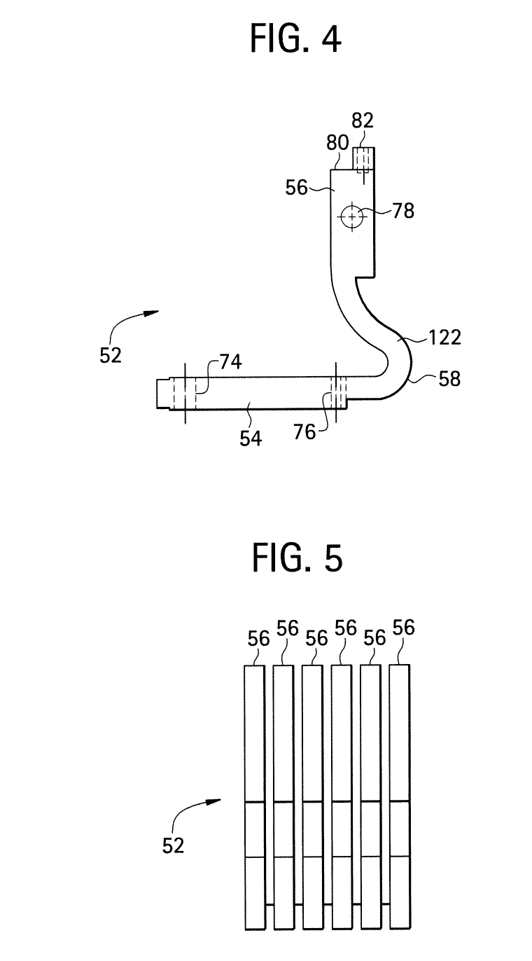

To improve performance and minimize manufacturing and assembly costs, the exemplary embodiment uses a unitary current path structure 52. The unitary current path structure 52 uses a single component to form the terminal portion 54, the flexible portion 58 and the movable portion 56 as illustrated in FIGS. 4-7. As will be discussed in more detail below, in the exemplary embodiment, the unitary current structure 52 is formed from a laminate assembly of electrically conductive sheets, such as copper for example, where the terminal portion 54 and movable portion 56 where the material for each of the sheets is contiguous, meaning formed from a single piece of material. The terminal portion 54 and movable portion 56 are solidified while the flexible portion 58 remains in a laminate form. It should be appreciated that while the term “sheet” is used herein, this term also encompasses other forms of electrically conductive materials that are commonly available in a generally planar form, such as braided materials and mesh materials for example.

The unitary current path structure 52 may also include a terminal portion 54, a plurality of flexible portions 58, and a plurality of movable portions 60. In this embodiment, there is a single movable portion 60 associated with each flexible portion 58. The terminal portion 54 may include one or more holes 74, 76 that provide attachment points to allow the removable coupling of the circuit breaker 30 from the electrical circuit 20. The movable portion 56 may also incorporate additional features, such as a hole 78 that is sized to receive the pin 66. The movable portion 56 may also include a cutout area 80 that receives the arc runner 68 and a threaded hole 82 that is used to couple the arc runner 68 to the movable portion 56 by means of a fastener for example. Finally, the movable portion 56 may also include other features, such as a recessed area 84 (FIG. 7) for example, that facilitates the placement and assembly of the movable contact 60 on to the movable portion 56.

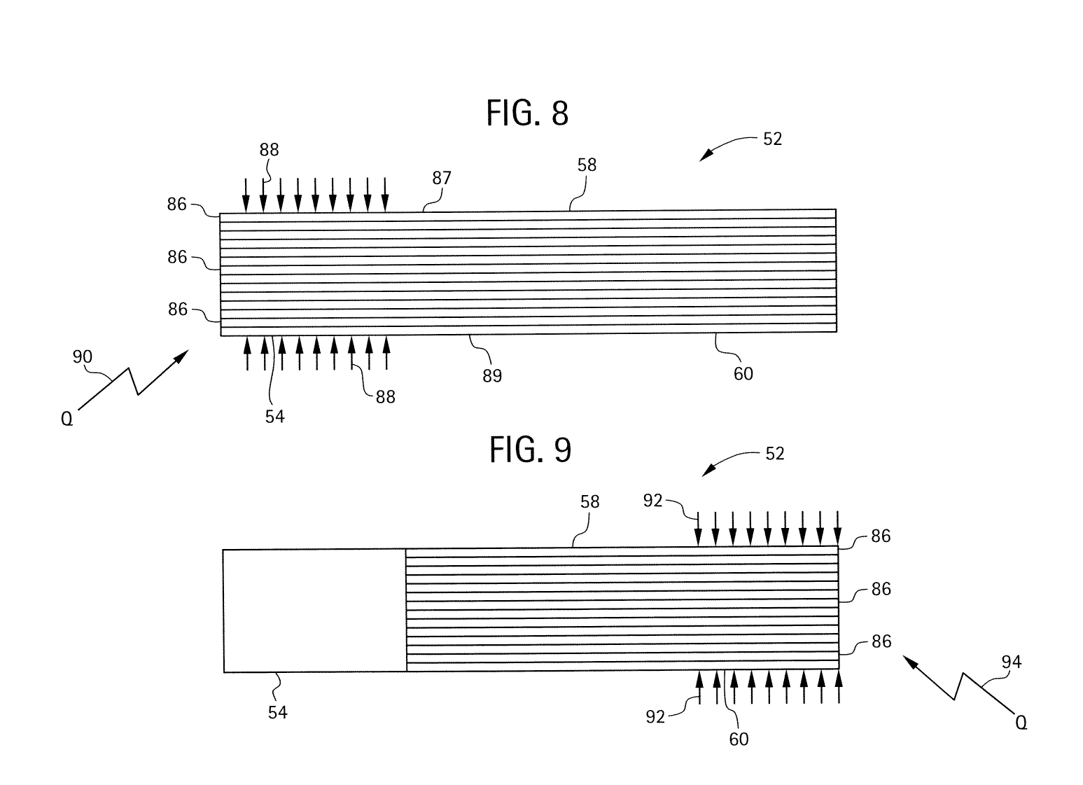

An exemplary process for forming the unitary current path structure 52 is illustrated in FIGS. 8-10. In this embodiment, a plurality of sheets 86 made from an electrically conductive material are stacked in a laminate arrangement. In the exemplary embodiment, the sheets are 0.14 mm thick and there are 140 sheets in the laminate. A force, represented by pressure arrows 88, is applied to the top surface 87 and the bottom surface 89 of laminated sheets 86 in the area of the terminal portion 54 as illustrated in FIG. 8. Coincident with the application of pressure, heat is added to the terminal portion 54 causing the sheets 86 to weld together. The energy to generate heat, represented by arrow 90, may be added by a number of processes, such as but not limited to, electric arc, gas flame, laser, electron beam, friction, and ultrasound. As such, these processes may also include resistance welding, oxyfuel welding, shielded metal arc welding, gas metal arc welding, flux-cored arc welding, and solid-state welding. The heat and pressure used in the process are sufficient to join the sheets 86 and solidify the terminal portion 54.

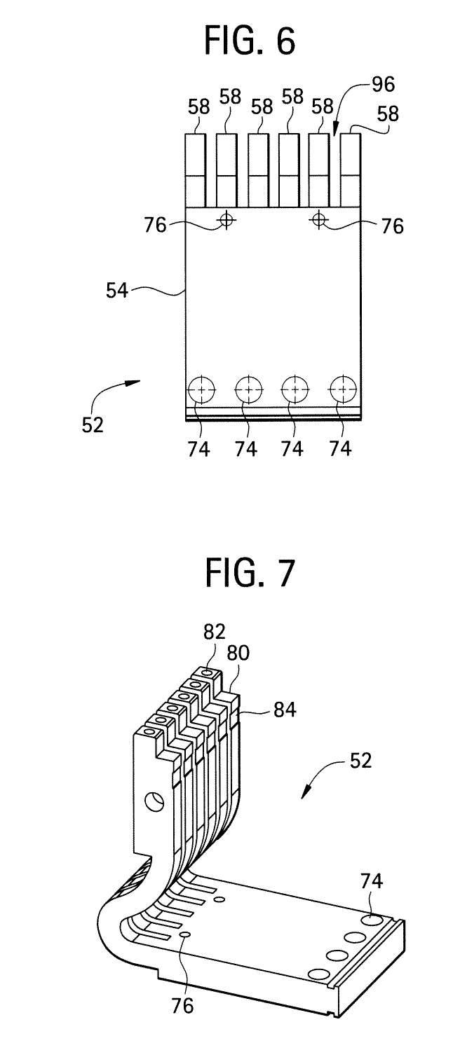

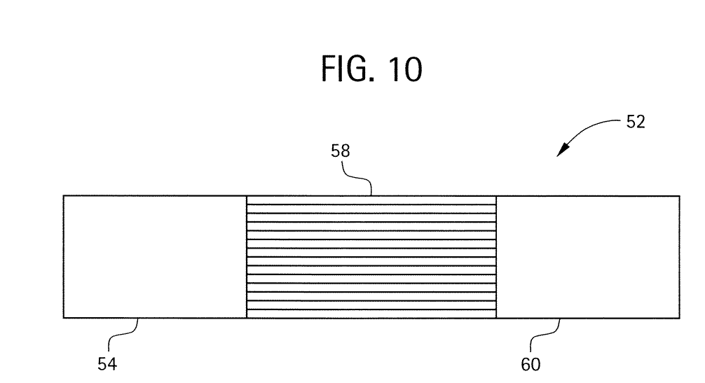

Next, as shown in FIG. 9, the unitary current path structure 52 is arranged to apply a force to the top surface 87 and the bottom surface 89 in the area of movable portion 56 as represented by pressure arrows 92. Similar to the solidification of terminal portion 54, heat is applied to the movable portion 56 causing the individual sheets 86 to weld together. The energy to generate the heat, represented by arrow 94, may be made by any suitable source capable of joining the sheets 86 together, such as those listed above for example. It should be appreciated that in embodiments having multiple movable portions 56, the spaces 96 (FIG. 6) between the respective movable portions 56 may be formed after the solidification process. Processes such as by a machining or stamping process may form the spaces 96 for example. Alternatively, these spaces 96 may be formed before solidification. Once the terminal portion 54 is solidified, the unitary current path structure 52 has essentially solid ends, with the flexible portion 58 remaining as a laminate as illustrated in FIG. 10.

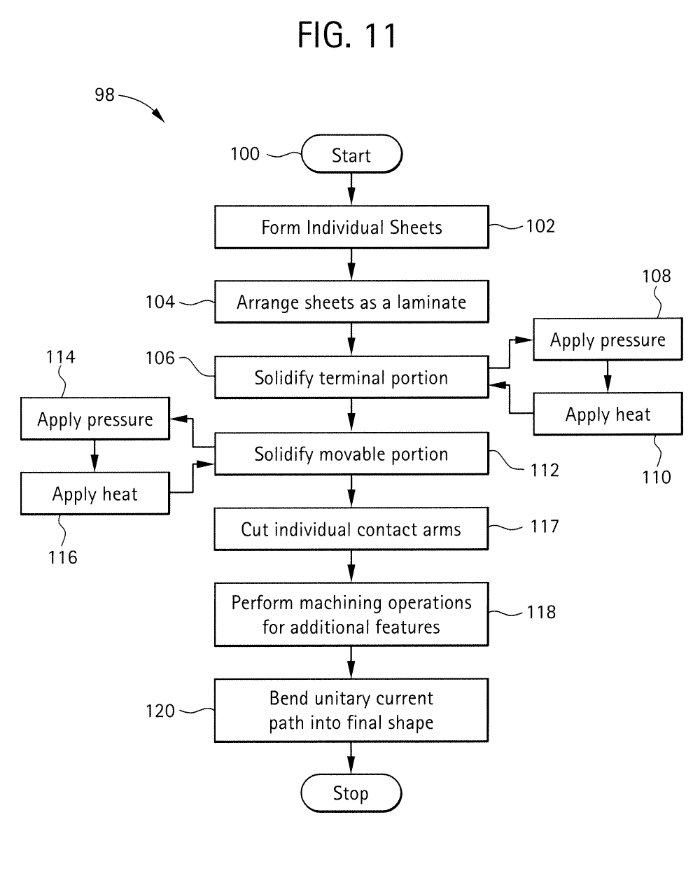

Another method 98 for fabricating the unitary current path structure 52 is illustrated in FIG. 11. In this embodiment, the method 98 begins in start block 100 and proceeds to block 102 where the sheets 86 are formed. Any suitable process that is appropriate for the desired material and thickness may form the sheets 86. The sheet forming process 102 may therefore be performed by machining, stamping, shearing, piercing, blanking, coining, progressive stamping or punching for example. It should be appreciated that certain features of the unitary current path structure 52, such as the spaces 96 may be formed during forming process 102. After the individual sheets 86 are formed, the method 98 proceeds to block 104 where the individual sheets 86 are stacked in a laminate arrangement to form the desired shape and thickness.

The method 98 then proceeds to block 106 where the terminal portion 54 is solidified through the application of pressure in block 108 and heat in block 110. Once the terminal portion 54 is solidified, the method 98 proceeds to block 112 where the movable portion 56 is solidified through the application of pressure in block 114 and heat in block 116. Once the terminal portion 54 and movable portion 56 are solidified, the method 98 proceeds to secondary operations that form the unitary current path structure 52 into its final desired configuration. These secondary operations include the cutting of the individual movable portions 56 in block 117. Additional subsequent machining operations in block 118 may also be performed, these operations may include the forming of holes 74 and recessed areas 84 for example. The secondary operations may also include bending operations in block 120 to form the curve 122 (FIG. 4) in the flexible portion 58.

It should be appreciated that the unitary current path structure described herein provides a number of advantages in performance and cost of fabrication. Since there are fewer joints in the current path between the inlet terminal 38 and the movable contact 60, the amount of heat generated during operation will be lower since the electrical resistance normally created at such joins is absent. Further, since fewer components are used substantial costs reductions may be realized through the reduction of inventory and lower assembly costs.

While the invention has been described with reference to exemplary embodiments, it will be understood that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A current path structure for a circuit breaker comprising:
a plurality of electrically conductive members arranged as a laminate, said plurality of electrically conductive members having a terminal portion, a movable portion, and a first flexible portion between said movable portion and said terminal portion, wherein material for each of said plurality electrically conductive members is contiguous between said terminal portion, said first flexible portion and said movable portion;
wherein each of said terminal portions of said plurality of electrically conductive sheets are electrically coupled to each other to form a unitary terminal; and,
wherein each of said movable portions of said plurality of electrically conductive sheets are electrically coupled to each other.

2. The current path structure for a circuit breaker of claim 1 wherein:
said unitary terminal is formed by solidifying each of said terminal portions of said plurality of electrically conductive sheets; and,
said movable portions of said electrically conductive sheets are electrically coupled to each other by solidifying each of said movable portions of said plurality of electrically conductive sheets.

3. The current path structure for a circuit breaker of claim 2 further comprising a first unitary contact arm and a second unitary contact arm formed from said solidified movable portion wherein material from said first unitary contact arm and said second unitary contact arm is contiguous with said unitary terminal.

4. The current path structure for a circuit breaker of claim 3 further comprising a second flexible portion between said second unitary contact arm and said terminal portion wherein material from said second flexible portion is contiguous with second unitary contact arm and said unitary terminal.

5. The current path structure for a circuit breaker of claim 4 further comprising a first movable contact coupled to an end of said first unitary contact arm opposite said first flexible portion, and a second movable contact coupled to an end of said second unitary contact arm opposite said second flexible portion.

6. The current path structure for a circuit breaker of claim 5 further comprising:
a third unitary contact arm formed from said solidified movable portion;
a fourth unitary contact arm formed from said solidified movable portion;
a fifth unitary contact arm formed from said solidified movable portion; and,
a sixth unitary contact arm formed from said solidified movable portion;
wherein material from said third unitary contact arm, said fourth unitary contact arm, said fifth unitary contact arm and said sixth unitary contact is contiguous with said unitary terminal.

7. The current path structure of claim 6 wherein said electrically conductive members is an electrically conductive metal foil, sheet, braid, or mesh material.

8. A circuit breaker comprising:
a housing;
a first terminal is mounted within said housing; and,
a unitary current path structure comprised of a plurality of individual planar members, each of said plurality of individual planar members having a terminal portion, a movable portion and a flexible portion between said terminal portion and said movable portion, wherein said terminal portions are electrically coupled to form a unitary second terminal, and said movable portions are electrically coupled to form a unitary contact arm;
wherein said unitary second terminal is coupled to said housing and said unitary current path is arranged such that said unitary contact arm is movable between a first position in electrical contact with said first terminal and a second position which is separated from said first terminal.

9. The circuit breaker of claim 8 wherein said terminal portion of said plurality of individual sheets is electrically coupled by solidification.

10. The circuit breaker of claim 8 wherein said movable portion of said plurality of individual sheets is electrically coupled by solidification.

11. The circuit breaker of claim 10 further comprising a plurality of contact arm portions formed from said movable portion after said movable portion is solidified.

12. A circuit breaker comprising:
a housing;
a mechanism within said housing;
a first terminal is positioned within said housing; and,
a current path structure coupled to said housing, said current path structure comprising:
a plurality of electrically conductive members arranged as a laminate, said plurality of electrically conductive members having a terminal portion, a movable portion, and a first flexible portion between said movable portion and said terminal portion, wherein material for each of said plurality electrically conductive members is contiguous between said terminal portion, said first flexible portion and said movable portion;
wherein each of said terminal portions of said plurality of electrically conductive sheets are electrically coupled to each other to form a unitary second terminal; and,
wherein each of said movable portions of said plurality of electrically conductive sheets are electrically coupled to each other to form at least one contact arm; and,
wherein said at least one contact arm is movable by said mechanism between a first position in electrical contact with said first terminal and a second position out of electrical contact with said first terminal.

13. The circuit breaker of claim 12 wherein said terminal portion of said plurality of individual sheets are electrically coupled by solidification.

14. The circuit breaker of claim 12 wherein said movable portion of said plurality of individual sheets are electrically coupled by solidification.

15. The circuit breaker of claim 14 further comprising a plurality of contact arm portions formed from said movable portion after said movable portion is solidified wherein material from said plurality of contact arm portions is contiguous with said unitary second terminal.

16. The circuit breaker of claim 15 further comprising a plurality of flexible portions between said plurality of contact arm portions and said unitary second terminal, wherein material from said plurality of flexible portions is contiguous with said plurality of contact arm portions and said unitary second terminal.

17. A method of fabricating a unitary contact path for a circuit breaker, said method comprising:
forming a plurality of individual electrically conductive sheets, said sheets each having a terminal portion, a flexible portion and a movable portion;
stacking said plurality of individual electrically conductive sheets in a laminate arrangement, wherein said terminal portion, said flexible portion and said movable portion for each of said plurality of individual sheets are aligned;
solidifying said terminal portion of said plurality of individual electrically conductive sheets to each other; and,
solidifying said movable portion of said plurality of individual electrically conductive sheets to each other;
wherein said flexible portion is disposed between and contiguous with said terminal portion and said movable portion allowing said movable portion to move relative to said terminal portion.

18. The method of claim 17 wherein said step of solidifying said terminal portions of said plurality of individual sheets is performed by applying a first heat and a first pressure to said terminal portion, wherein said first pressure is applied to a first portion of a first surface and a second surface of said plurality of individual sheets when said plurality of individual sheets are arranged in said laminate arrangement.

19. The method of claim 18 wherein said step of solidifying said movable portions of said plurality of individual sheets is performed by applying a second heat and a second pressure to said movable portion, wherein said second pressure is applied to a second portion of said first surface and said second surface of said plurality of individual sheets when said plurality of individual sheets are arranged in said laminate arrangement.

20. The method of claim 17 further comprising the step of forming a plurality of contact arms from said solidified movable portion.
